(19) United States
(12) Patent Application Publication
(10) Pub. No.: US 2016/0370694 A1
(43) Pub. Date: Dec. 22, 2016

(54) PROJECTION APPARATUS AND LIGHT INTEGRATION ROD FOR THE SAME

(71) Applicants: Qisda Optronics (Suzhou) Co., Ltd., Suzhou (CN); Qisda Corporation, Taoyuan (TW)

(72) Inventors: CHIA-MING CHANG, Taichung (TW); CHING-SHUAI HUANG, Taoyuan (TW)

(21) Appl. No.: 15/185,028

(22) Filed: Jun. 17, 2016

(30) Foreign Application Priority Data
Jun. 22, 2015 (TW) 104120038

(51) Int. Cl. G03B 21/20

(52) U.S. Cl. CPC G03B 21/208

(57) ABSTRACT

A projection apparatus includes a light source module for providing an illuminating light beam, a light integration rod disposed between the light source module and a light valve configured for converting the illuminating light beam into an image light beam, and a projection lens disposed on a transmission path of the image light beam. The light integration rod includes a light input end and a light output end opposite to the light input end; the light input end includes a plurality of first sides having a length of X1 and a plurality of second sides having a length of Y1; and the light output end includes a plurality of third sides having a length of X2 and opposite to the first sides and a plurality of fourth sides having a length of Y2 and opposite to the second sides, wherein X2/X1>Y2/Y1.

### FIELD OF THE INVENTION

The present invention relates to a projection apparatus, and more particularly to a projection apparatus and a light integration rod for the same.

### BACKGROUND OF THE INVENTION

In the design of a digital light processing (DLP) projector, on-, off- and flat-states optical paths in respective of the position of the projection lens aperture has to be considered. The on-, off- and flat-states optical paths correspond to the positions of micromirrors in the digital micromirror device (DMD). In other words, on-state optical path is the transmission path of light beams reflected by on-state micromirrors (or “on-state light beam” hereinafter), and would pass through the projection lens; analogously, off-state optical path is the transmission path of light beams reflected by off-state micromirrors (or “off-state light beam” hereinafter), and would deviate from entering the projection lens; otherwise, flat-state optical path is the transmission path of light beams reflected by flat-state micromirrors (or “flat-state light beam” hereinafter).

To improve light utilization efficiency of the projectors, projection lenses with larger apertures are typically chosen so as to increase the area of light reception. FIG. 1 illustrates the positions of on-state, flat-state and off-state light beams in respect to the aperture as known in the prior art. As shown in FIG. 1, when a projection lens with a large aperture 10 is used, an on-state light beam L1 would entirely pass through the aperture 10, thus improving light utilization efficiency of the projection device; on the contrary, an off-state light beam L2 would not enter the aperture 10. However, a minor portion of a flat-state light beam L3 would enter the aperture 10, leading to contrast reduction of the projection device.

While light leakage caused by flat-state light beams entering the aperture may be avoid by adopting a projection lens with a smaller aperture, on-state light beams may not be able to pass through the aperture fully, therefore resulting in reduction in light utilization efficiency of the projection device.

### BRIEF SUMMARY OF THE INVENTION

Therefore, the present invention provides a projection apparatus with enhanced light utilization efficiency and contrast.

Another embodiment of the present invention provides a light integration rod for enhancing the light utilization efficiency and contrast of the projection apparatus.

The projection apparatus according to an embodiment of the present invention includes a light source module, a light valve, a light integration rod, and a projection lens. The light source module is configured for providing an illuminating light beam. The light valve is disposed on the transmission path of the illuminating light beam for converting the illuminating light beam into an image light beam. The light integration rod is disposed between the light source module and the light valve. The light integration rod includes a light input end and a light output end opposite to the light input end; the light input end includes a plurality of first sides having a length of X1 and a plurality of second sides having a length of Y1; and the light output end includes a plurality of third sides having a length of X2 and opposite to the first sides and a plurality of fourth sides having a length of Y2 and opposite to the second sides, wherein X2/X1>Y2/Y1. The projection lens is disposed on the transmission path of the image light beam.

The light integration rod according to an embodiment of the present invention includes a light input end and a light output end opposite to the light input end. The light input end includes a plurality of first sides having a length of X1 and a plurality of second sides having a length of Y1; and the light output end includes a plurality of third sides having a length of X2 and opposite to the first sides and a plurality of fourth sides having a length of Y2 and opposite to the second sides, wherein X2/X1>Y2/Y1.

In an embodiment of the present invention, the shape of the light output end of the light integration rod corresponds to the shape of the active surface of the light valve.

In an embodiment of the present invention, the shape of the light input end of the light integration rod corresponds to the shape of the output surface of the light source module.

In an embodiment of the present invention, the first sides and the third sides are parallel to a first direction, the second sides and the fourth sides are parallel to a second direction, and the first direction is perpendicular to the second direction.

In an embodiment of the present invention, X1<X2.

In an embodiment of the present invention, Y1>Y2.

In an embodiment of the present invention, Y1<Y2.

In an embodiment of the present invention, X1<Y1.

In the projection apparatus according to the embodiments of the present invention, the light integration rod includes a first side with a length of X1 and a second side with a length of Y1 at the light input end and a third side with a length of X2 and a fourth side with a length of Y2 at the light output end, which satisfy the equation: X2/X1>Y2/Y1, so that images of exit pupil of the illuminating light beam at the light output end of the light integration rod are effectively narrowed. In this way, on-state light beams are fully utilized by the projection apparatus and light leakage caused by flat-state light beams is prevented. Therefore, the light integration rod of the present invention is effective in enhancing light utilization efficiency and contrast of the projection apparatus.

For making the above and other purposes, features and benefits become more readily apparent to those ordinarily skilled in the art, the preferred embodiments and the detailed descriptions with accompanying drawings will be put forward in the following descriptions.

### BRIEF DESCRIPTION OF THE DRAWINGS

The present invention will become more readily apparent to those ordinarily skilled in the art after reviewing the following detailed description and accompanying drawings, in which:

FIG. 1 is a schematic illustration of the positions of on-state, flat-state and off-state light beams in respect to the aperture as known in the prior art;

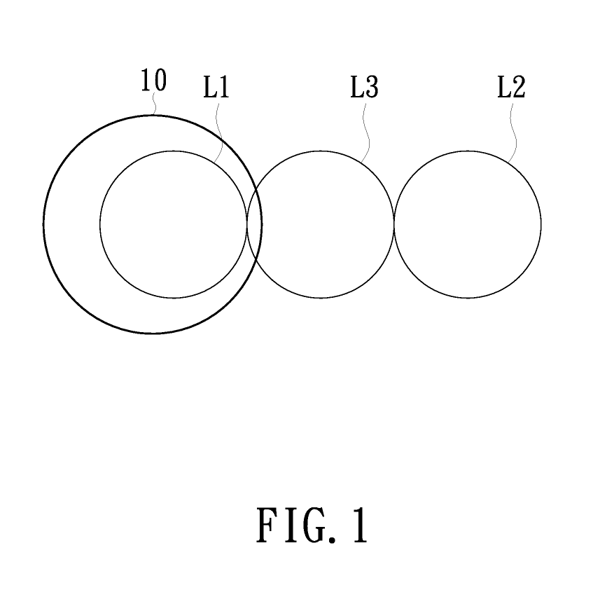

FIG. 2 is a schematic illustration of a projection device according to an embodiment of the present invention;

FIG. 3 is a schematic three-dimensional view of the light integration rod of FIG. 2;

FIG. 4A is a schematic illustration of the optical path of illuminating light beams within the integration rod along plane Y-Z according to an embodiment of the present invention;

FIG. 4B is a schematic illustration of the optical path of illuminating light beams within the integration rod along plane X-Z according to an embodiment of the present invention;

FIG. 5 is a s schematic illustration of the positions of on-state, flat-state and off-state light beams in respect to the aperture according to an embodiment of the present invention; and

FIG. 6 is a schematic three-dimensional view of the light integration rod according to another embodiment of the present invention.

### DETAILED DESCRIPTION OF THE INVENTION

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

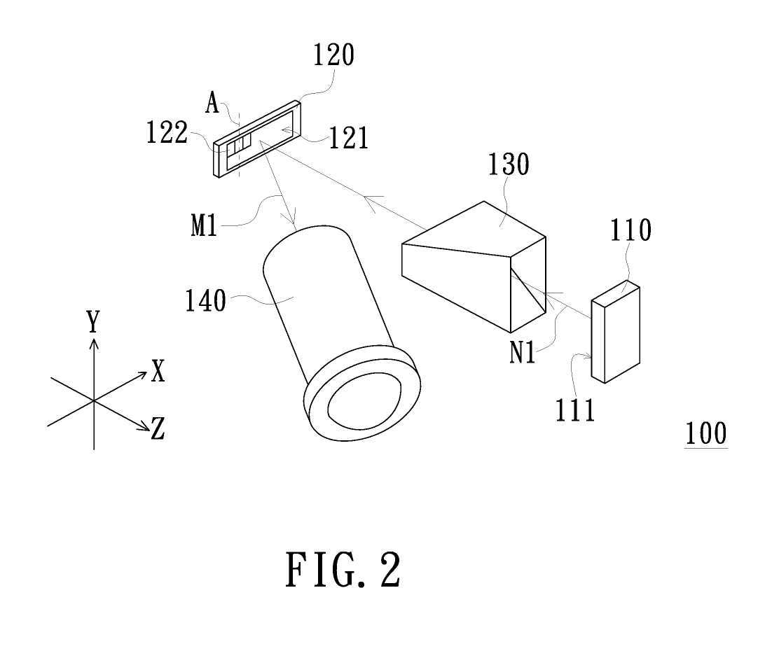

Referring now to FIG. 2. The projection apparatus 100 of the present embodiment includes a light source module 110, a light valve 120, a light integration rod 130, and a projection lens 140. The light source module 110 is configured for providing an illuminating light beam N1. The light valve 120 is disposed on the transmission path of the illuminating light beam N1 for converting the illuminating light beam N1 into an image light beam M1. The projection lens 140 is disposed on the transmission path of the image light beam M1 for projecting the image light beam M1 onto a screen, thus displaying an image on the screen. The light integration rod 130 is disposed on the transmission path of the illuminating light beam N1 and between the light source module 110 and the light valve 120. The light integration rod 130 homogenizes the illuminating light beam N1 and adjusts the images of exit pupil of the illuminating light beam N1 to non-circular images. The light integration rod 130 may be, but is not limited to, a hollow column or a solid column.

The light source module 110 of the present embodiment may include at least one light-emitting diode (LED) component, but is not limited to any specific type of light source. Optical lenses, reflective sheets, prisms, or other optical components may be disposed between the light source module 110 and the light integration rod 130 or between the light integration rod and the light valve 120 according to specific needs. The light valve 120 of the present embodiment is a reflective light valve, such as a digital micromirror component comprised of a plurality of micromirrors 122 that are arranged in arrays. It is to be understood that FIG. 2 exemplarily illustrates only a portion of the micromirrors 122. Each of the micromirrors 122 includes a shaft A for the micromirror 122 to rotate in respect to the shaft A within a defined range (eg. ±12° or ±10°). In the present embodiment, the reflective surface of the micromirror 122 at flat-state may be parallel to plane X-Y, and the shaft A of the micromirror 122 may be parallel to axis Y.

The present invention modifies the structure of existing light integration rods, with the aim of enhancing both the light utilization efficiency and the contrast of projection devices. Structure of the light integration rod 130 of the present embodiment is described in detail as follows.

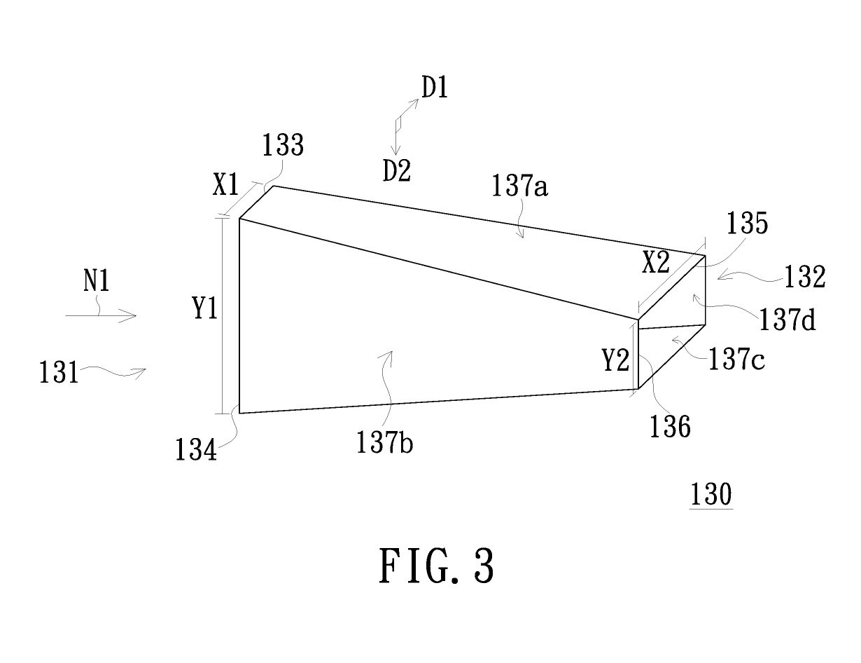

Referring now to FIG. 3. The light integration rod 130 includes a light input end 131 and a light output end 132 opposite to the light input end 131. The illuminating light beam N1 enters the light integration rod 130 from the light input end 131, and exits from the light output end 132. The light input end 131 includes a plurality of first sides 133 having a length of X1 and a plurality of second sides 134 having a length of Y1. The light output end 132 includes a plurality of third sides 135 having a length of X2 and opposite to the first sides 133, and a plurality of fourth sides 136 having a length of Y2 and opposite to the second sides 134. The lengths of the sides satisfy the equation: X2/X1>Y2/Y1.

In the present embodiment, the light input end 131 of the light integration rod 130 is rectangular, and has two opposite first sides 133 and two opposite second sides 134 that are perpendicular to the first sides 133. Length X1 of the first sides 133 is smaller than length Y1 of the second sides 134. The light output end 132 of the light integration rod 130 may also be rectangular, and has two opposite third sides 135 and two opposite fourth sides 136 that are perpendicular to the third sides 135. The first sides 133 and the third sides 135 are parallel to a first direction D1, and the second sides 134 and the fourth sides 136 are parallel to a second direction D2. The first direction D1 is perpendicular to the second direction D2; for example, the first direction D1 may be parallel to axis X as shown in FIG. 2, and the second direction D2 may be parallel to axis Y, so that the fourth sides 136 of the light output end 132 of the light integration rod 130 is parallel to the shafts A of the micromirrors 122. It is to be understood however that the present invention is not limited thereto, and that the relative position between the light integration rod 130 and the light valve 120 may be adjusted according to specific needs.

The light integration rod 130 further includes a plurality of lateral surfaces between the light input end 131 and the light output end 132. In the present embodiment, the light integration rod 130 has four lateral surfaces 137a, 137b, 137c and 137d; however, the present invention is not limited thereto. The lateral surface 137a is opposite to the lateral surface 137c, and the lateral surface 137b is opposite to the lateral surface 137d. The lateral surfaces 137a and 137c diverge along direction -Z (that is, from the light input end 131 toward the light output end 132), while the lateral surfaces 137b and 137d converge along the same direction -Z. All of the lateral surfaces 137a, 137b, 137c and 137d are trapezoidal, therefore resulting in X2>X1 and Y2<Y1.

In the present embodiment, length X1 of the first sides 133 and length Y1 of the second sides 134 at the light input end 131 and length X2 of the third sides 135 and length Y2 of the fourth sides 136 at the light output end 132 satisfy the equation: |(X2−X1)/X1|>|(Y2−Y1)/Y1|. In other words, the trend change between the light input end 131 and the light output end 132 along the first direction D1 is greater than that along the second direction D2, or simply X2/X1>Y2/Y1. Narrowing of the illuminating light beam N1 and adjustment of the images of exit pupil at the light output end 132 to non-circular images by the light integration rod 130 are described in detail as follows.

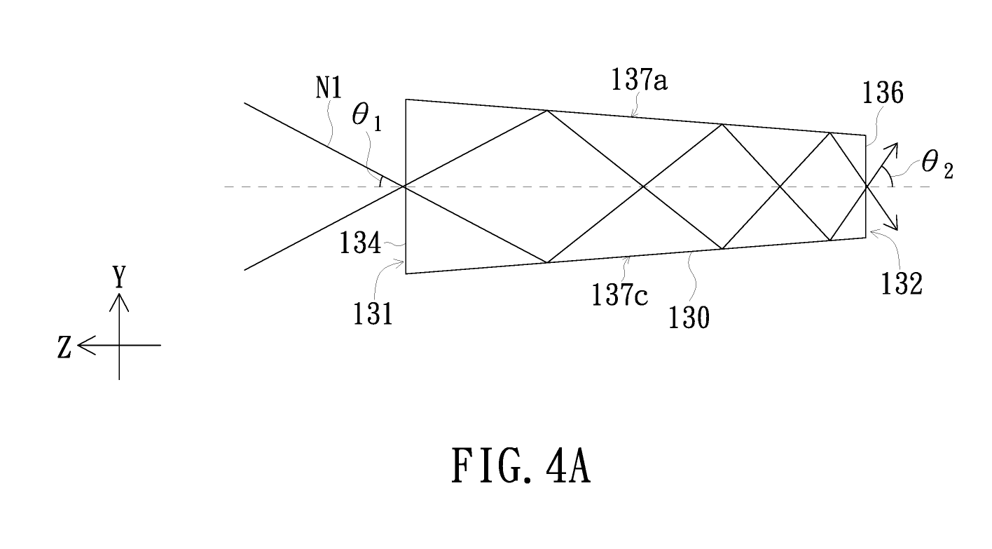

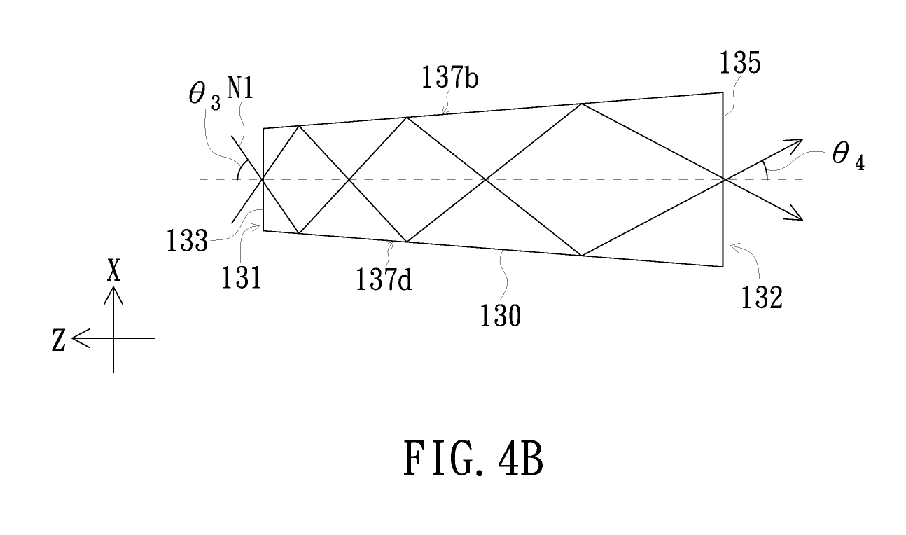

Referring now to FIGS. 4A and 4B. As illustrated in FIG. 4A, the illuminating light beam N1 is multiply reflected by the lateral surfaces 137a and 137c in side of the light integration rod 130 according to the laws of reflection. As the length of the light integration rod 130 on the Y direction shortens along the direction -Z, the angles of incidence and/or reflection of the illuminating light beam N1 at the lateral surfaces 137a and 137c gradually increase, causing the angle of output θ₂ of the illuminating light beam N1 at the light output end 132 to be greater than the angle of input θ₁ at the light input end 131. Similarly, as shown in FIG. 4B, the illuminating light beam N1 performs a multiple reflection at the lateral surfaces 137b and 137d in side of the light integration rod 130. According to the laws of reflection, as the length of the light integration rod 130 on the X direction increases along the direction -Z, the angle of output θ₄ of the illuminating light beam N1 at the light output end 132 would be smaller than the angle of input θ₃ at the light input end 131.

Accordingly, as the angle of output θ₄ is smaller than the angle of input θ₃ and the angle of output θ₂ is greater than the angle of input θ₁, the length of the illuminating light beam N1 along axis Y would be greater than that along axis X, therefore forming a non-circular image of exit pupil at the light output end 132. The illuminating light beam N1 would then be converted into the image light beam M1 by the light valve 120 and incident the projection lens 140. Consequently, the image of entrance pupil of the image light beam M1 transmitted to the projection lens 140 would be similar to elliptical in shape.

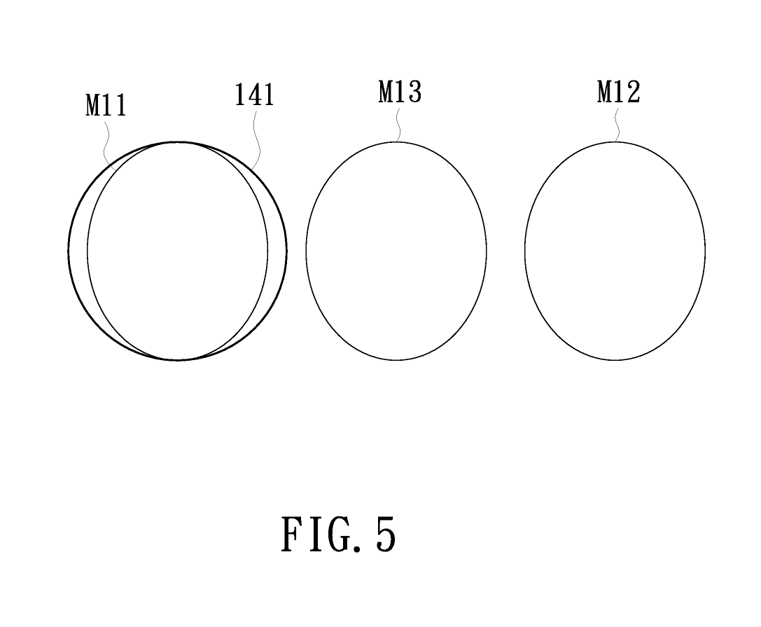

Referring now to FIG. 5. As the image of exit pupil of the image light beam M1 at the light output end 132 is elliptical, on-state light beams M11 (or image light beams reflected by on-state micromirrors) can entirely pass through aperture 141 of the projection lens 140, while neither flat-state light beams M13 (or image light beams reflected by flat-state micromirrors) nor off-state light beams M12 (or image light beams reflected by off-state micromirrors) would enter the aperture 141. Therefore, the present invention solves the issue of leakage of flat-state light beams as seen in the prior art, and the projection apparatus 100 using the light integration rod of the present embodiment exhibits enhanced light utilization efficiency and contrast.

Referring again to FIGS. 2 and 3. The shape of the light output end 131 of the light integration rod 130 corresponds to the shape of the light output surface 111 of the light source module 110. For example, the light input end 131 and the light output surface 111 are both rectangular, and the sides of the rectangle at the light input end 131 correspond to those of the rectangle at the light output surface 111. In this way, light loss of the illuminating light beam N1 provided by the light source module 110 during entry into the light integration rod 130 from the light input end 131 can be avoided. Similarly, to improve light utilization efficiency, the shape of the light input end 132 of the light integration rod 130 also corresponds to the shape of the active surface 121 of the light valve 120, so that the illuminating light beam N1 emitted from the light output end 132 of the light integration rod 130 would substantially cover the entire active surface 121 of the light valve 120.

It is to be understood that the present invention is not limited to Y2<Y1 as exemplified in the aforementioned embodiment. In another embodiment, lengths of the sides the light integration rod 130 may satisfy the equation: Y2>Y1. Narrowing of the image of exit pupil of the illuminating light beam N1 at the light output end 132 can be accomplished as long as X2/X1>Y2/Y1 or |(X2−X1)/X1|>|(Y2−Y1)/Y1| is satisfied

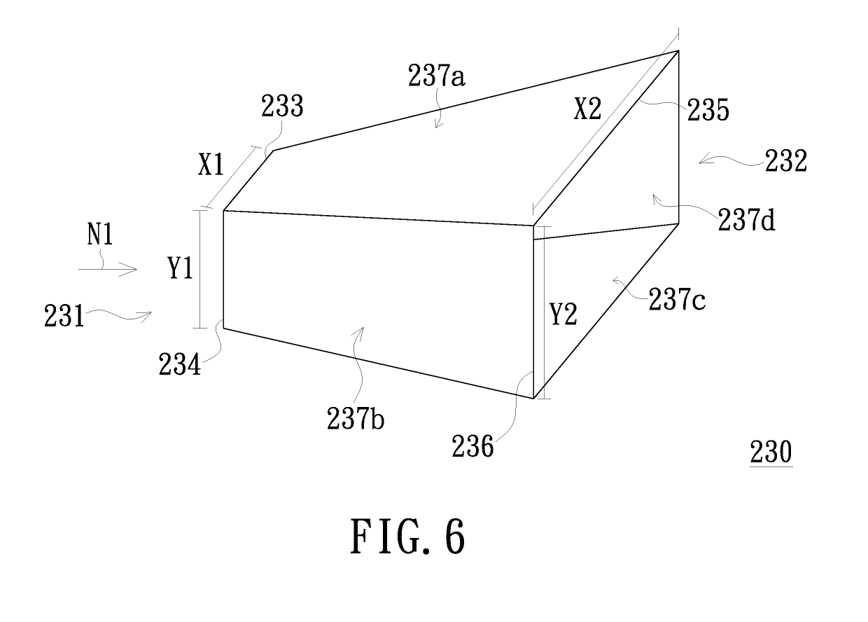

Referring now to FIG. 6. The light integration rod 230 includes a light input end 231 and a light output end 232 opposite to the light input end 231. The illuminating light beam N1 enters the light integration rod 130 from the light input end 231, and exits from the light output end 232. The light input end 231 includes a plurality of first sides 233 having a length of X1 and a plurality of second sides 234 having a length of Y1. The light output end 232 includes a plurality of third sides 235 having a length of X2 and opposite to the first sides 233 and a plurality of fourth sides 236 having a length of Y2 and opposite to the second sides 234. The lengths of the sides satisfy the equation: X2/X1>Y2/Y1.

In the present embodiment, the light input end 231 of the light integration rod 230 is rectangular, and has two opposite first sides 233 and two opposite second sides 234 that are perpendicular to the first sides 233. The light output end 232 of the light integration rod 230 may also be rectangular, and has two opposite third sides 235 and two opposite fourth sides 236 that are perpendicular to the third sides 235. The light integration rod 230 further includes a plurality of lateral surfaces between the light input end 231 and the light output end 232. In the present embodiment, the light integration rod 230 has four lateral surfaces 237a, 237b, 237c and 237d; but note the present invention is not limited thereto. The lateral surface 237a is opposite to the lateral surface 237c, and the lateral surface 237b is opposite to the lateral surface 237d. All of the lateral surfaces 237a, 237b, 237c and 237d diverge from the light input end 231 toward the light output end 232 and are all trapezoidal, therefore resulting in X1<X2 and Y1<Y2.

In the present embodiment, as length X1 of the first sides 233 and length Y1 of the second sides 234 at the light input end 231 and length X2 of the third sides 235 and length Y2 of the fourth sides 236 at the light output end 232 satisfy the equation: X2/X1>Y2/Y1, narrowing of the illuminating light beam N1 and adjustment of the images of exit pupil at the light output end 232 to non-circular images are accomplished.

In sum, the projection apparatus according to the aforementioned embodiments of the present invention, the light integration rod includes a first side with a length of X1 and a second side with a length of Y1 at the light input end and a third side with a length of X2 and a fourth side with a length of Y2 at the light output end, which satisfy the equation: X2/X1>Y2/Y1, so that images of exit pupil of the illuminating light beam at the light output end of the light integration rod are effectively narrowed to non-circular images. In this way, on-state light beams are fully utilized by the projection apparatus and light leakage caused by flat-state light beams is prevented. Therefore, the light integration rod of the present invention is effective in enhancing light utilization efficiency and contrast of the projection apparatus.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A projection apparatus, comprising:
a light source module, configured for providing an illuminating light beam;
a light valve, disposed on a transmission path of the illuminating light beam for converting the illuminating light beam into an image light beam;
a light integration rod, disposed between the light source module and the light valve, the light integration rod comprising a light input end and a light output end opposite to the light input end, the light input end comprising a plurality of first sides having a length of X1 and a plurality of second sides having a length of Y1, the light output end comprising a plurality of third sides having a length of X2 and opposite to the first sides and a plurality of fourth sides having a length of Y2 and opposite to the second sides, wherein X2/X1>Y2/Y1; and
a projection lens, disposed on a transmission path of the image light beam.

2. The projection apparatus according to claim 1, wherein a shape of the light output end of the light integration rod corresponds to a shape of an active surface of the light valve.

3. The projection apparatus according to claim 1, wherein a shape of the light input end of the light integration rod corresponds to a shape of an output surface of the light source module.

4. The projection apparatus according to claim 1, wherein the first sides and the third sides are parallel to a first direction, the second sides and the fourth sides are parallel to a second direction, and the first direction is perpendicular to the second direction.

5. The projection apparatus according to claim 1, wherein X1<X2.

6. The projection apparatus according to claim 5, wherein Y1>Y2.

7. The projection apparatus according to claim 5, wherein Y1<Y2.

8. The projection apparatus according to claim 1, wherein X1<Y1.

9. A light integration rod, comprising a light input end and a light output end opposite to the light input end, the light input end comprising a plurality of first sides having a length of X1 and a plurality of second sides having a length of Y1, the light output end comprising a plurality of third sides having a length of X2 and opposite to the first sides and a plurality of fourth sides having a length of Y2 and opposite to the second sides, wherein X2/X1 >Y2/Y1.

10. The light integration rod according to claim 9, wherein the first sides and the third sides are parallel to a first direction, the second sides and the fourth sides are parallel to a second direction, and the first direction is perpendicular to the second direction.

11. The light integration rod according to claim 9, wherein X1<X2.

12. The light integration rod according to claim 11, wherein Y1>Y2.

13. The projection apparatus according to claim 11, wherein Y1<Y2.

14. The projection apparatus according to claim 9, wherein X1<Y1.
